(19) United States
(12) Patent Application Publication
(10) Pub. No.: US 2019/0310579 A1
(43) Pub. Date: Oct. 10, 2019

(54) TRANSPORT DEVICE AND IMAGE FORMING APPARATUS

(71) Applicant: FUJI XEROX CO., LTD., Tokyo (JP)

(72) Inventors: Takehiko KOIZUMI, Kanagawa (JP); Yoshinori KOIKE, Kanagawa (JP); Takuyoshi KIMURA, Kanagawa (JP); Natsumi NAKATA, Kanagawa (JP)

(73) Assignee: FUJI XEROX CO., LTD., TOKYO (JP)

(21) Appl. No.: 16/109,680

(22) Filed: Aug. 22, 2018

(30) Foreign Application Priority Data
Apr. 6, 2018 (JP) 2018-074184

(51) Int. Cl. G03G 15/00; B65H 5/06

(52) U.S. Cl. CPC G03G 15/6529; B65H 2404/111; B65H 5/062

(57) ABSTRACT

A transport device including: a first transporting part that transports a medium; and a second transporting part that includes a pair of transport members each having a shaft and multiple rotary members arranged at intervals in an axial direction. The second transporting part transports the medium while nipping the medium between the pair of transport members after a leading end of the medium transported by the first transporting part comes into contact with the transport members. At least one of the multiple rotary members of one transport member is a circular-truncated-cone-shaped rotary member in which a diameter of one base is larger than a diameter of the other base.

### CROSS-REFERENCE TO RELATED APPLICATIONS

This application is based on and claims priority under 35 USC 119 from Japanese Patent Application No. 2018-074184 filed Apr. 6, 2018.

### BACKGROUND

### Technical Field

The present invention relates to a transport device and an image forming apparatus.

### SUMMARY

According to an aspect of the invention, there is provided a transport device including: a first transporting part that transports a medium; and a second transporting part that includes a pair of transport members each having a shaft and multiple rotary members arranged at intervals in an axial direction. The second transporting part transports the medium while nipping the medium between the pair of transport members after a leading end of the medium transported by the first transporting part comes into contact with the transport members. At least one of the multiple rotary members of one transport member is a circular-truncated-cone-shaped rotary member in which a diameter of one base is larger than a diameter of the other base.

### BRIEF DESCRIPTION OF THE DRAWINGS

Exemplary embodiments of the present invention will be described in detail based on the following figures, wherein:

FIG. 1 is a schematic view of an image forming apparatus according to exemplary embodiments of the present invention;

FIG. 2 is a side view showing the configuration of a third rotation member according to a first exemplary embodiment;

FIG. 3 is a side view of the third rotation member and a fourth rotation member that are in contact with each other in the first exemplary embodiment;

FIG. 4A is a plan view showing the positional relationship between a first transporting part and a second transporting part in the first exemplary embodiment and a state in which a sheet is transported from the first transporting part to the second transporting part;

FIG. 4B is a plan view showing a state in which the sheet is in contact with the second transporting part;

FIG. 4C is a plan view showing a state of the sheet being transported by the first transporting part and the second transporting part;

FIG. 5 is a schematic front view showing the positional relationship between transport devices (the first transporting part and the second transporting part) and a transfer unit in the first exemplary embodiment;

FIG. 6 is a side view showing another configuration of the third rotation member in the first exemplary embodiment;

FIG. 7 is a side view showing the configuration of a third rotation member in a second exemplary embodiment;

FIG. 8A is a plan view showing the positional relationship between a first transporting part and a second transporting part in the second exemplary embodiment and a state in which a sheet is transported from the first transporting part to the second transporting part;

FIG. 8B is a plan view showing a state in which the sheet is in contact with the second transporting part in the second exemplary embodiment;

FIG. 8 C is a plan view showing a state of the sheet being transported by the first transporting part and the second transporting part in the second exemplary embodiment;

FIG. 9 is a side view showing another configuration of the third rotation member in the second exemplary embodiment;

FIG. 10 is a perspective view showing the structure of a moving mechanism of the second transporting part in a third exemplary embodiment;

FIG. 11A is a side view of the third rotation member and a fourth rotation member that are in contact with each other in the third exemplary embodiment;

FIG. 11B is a side view of the third rotation member and the fourth rotation member that are separated from each other after the state shown in FIG. 11A has lasted for a long time, the outer circumferential surface of the rollers of the fourth rotation member being deformed;

FIG. 11C is a side view of the third rotation member and the fourth rotation member that are separated from each other after the state shown in FIG. 11A has lasted for a short time, the outer circumferential surface of the rollers of the fourth rotation member being not deformed;

FIG. 12 is a flowchart showing control of the moving mechanism in the third exemplary embodiment;

FIG. 13A is a plan view showing the positional relationship between a first transporting part and a second transporting part in Comparison Example 1 and a state in which the first transporting part is transporting a sheet;

FIG. 13B is a plan view showing a state in which the sheet is in contact with the second transporting part in Comparison Example 1;

FIG. 13C is a plan view showing a state of the sheet transported by the second transporting part in Comparison Example 1;

FIG. 14A is a plan view showing the positional relationship between a first transporting part and a second transporting part in Comparison Example 2 and a state in which the first transporting part is transporting a sheet;

FIG. 14B is a plan view showing a state in which the sheet is in contact with the second transporting part in Comparison Example 2; and

FIG. 14C is a plan view showing a state of the sheet transported by the second transporting part in Comparison Example 2.

### DETAILED DESCRIPTION

### First Exemplary Embodiment

Exemplary embodiments of a transport device and an image forming apparatus of the present invention will be described below with reference to the drawings.

In the figures, the direction indicated by arrow H is the apparatus height direction, and the direction indicated by arrow W is the apparatus width direction. Furthermore, the direction indicated by a circle with reference sign D or indicated by arrow D, which is perpendicular to both the apparatus height direction and the apparatus width direction, is the apparatus depth direction (arrow D is pointing the near side in the apparatus depth direction).

### Overall Configuration of Image Forming Apparatus

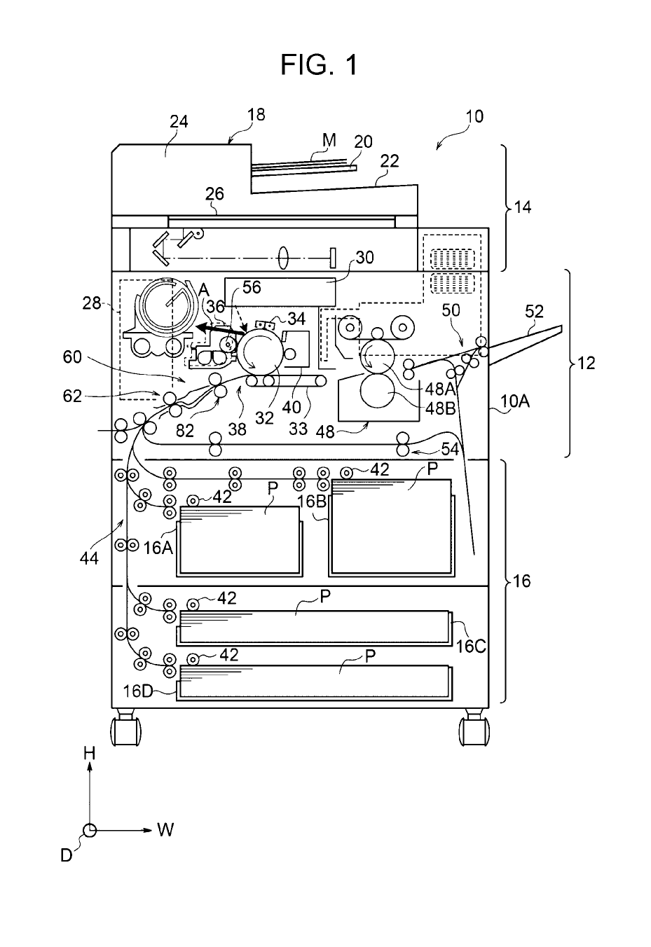

FIG. 1 shows an example configuration of an image forming apparatus 10 including a transport device 60 according to a first exemplary embodiment of the present invention.

As shown in FIG. 1, the image forming apparatus 10 includes an image forming section 12 that forms an image on a sheet P, an image reading section 14 that reads an image on a document, and a tray unit 16 provided below the image forming section 12 to accommodate sheets P.

The image reading section 14 includes an automatic document feeder 18. The automatic document feeder 18 includes a document tray 20 on which documents M are loaded, an output tray 22 on which the documents M after being subjected to image reading are output, and a transporting part 24 that transports the documents M from the document tray 20 to the output tray 22.

A user interface 26 (UI 26) that displays the state of the image forming apparatus 10 is provided in front of the image reading section 14. The UI 26 also allows a user to instruct a processing operation (service) item, including image reading processing, copying processing, and image forming processing, and to instruct detailed settings of each processing operation.

The image forming apparatus 10 includes a controller 28 that controls the image forming section 12 and the image reading section 14 in a centralized manner. For example, the controller 28 temporarily stores image data of the image on a document read in the image reading section 14 and transmits the image data to the image forming section 12.

The image forming section 12 includes an exposure device 30 that outputs a laser beam. A photoconductor 32 is disposed below the exposure device 30 in FIG. 1, and the photoconductor 32 is irradiated with the laser beam.

A charging unit 34, a developing device 36, a transfer unit 38, and a cleaner unit 40 are provided on the circumferential surface of the photoconductor 32 in this order in the counterclockwise direction in FIG. 1. The laser beam output from the exposure device 30 is radiated on a surface portion of the photoconductor 32 between the charging unit 34 and the developing device 36.

In this exemplary embodiment, as shown in FIG. 1, the transfer unit 38 includes the photoconductor 32 and an opposing belt 33 that is in contact with the photoconductor 32. The opposing belt 33 may alternatively be an opposing roller.

The tray unit 16 includes paper feed trays 16A, 16B, 16C, and 16D each containing a stack of sheets P.

In each of the paper feed trays 16A, 16B, 16C, and 16D, a pickup roller 42 picks up the top sheet P, and the sheet P is transported by a transporting part 44 including multiple rollers and guide plates.

The transporting part 44 includes a transport device 60 (described below) disposed on the downstream side of the tray unit 16 and on the upstream side of the transfer unit 38 in the sheet transport direction.

The transport device 60 aligns the position of a toner image formed on the photoconductor 32 and the position of the leading end of a sheet P.

A fixing device 48 is disposed on the downstream side of the transfer unit 38. The fixing device 48 includes a heating roller 48A and a pressure roller 48B. By applying heat and pressure to the sheet P, the toner image transferred to the sheet P is fixed thereon.

A sheet guide unit 50, serving as an example of transport guide unit, is provided on the downstream side of the fixing device 48 in the transport direction.

The sheet guide unit 50 changes the sheet transport direction to a designated direction. For example, the sheet guide unit 50 guides a sheet P sent from the fixing device 48 to a paper output tray 52. The sheet guide unit 50 also guides the sheet P sent from the fixing device 48 to a reversing path 54 and to the upstream side of the transport device 60 again so that an image is formed on the back of the sheet P.

In the image forming section 12, the controller 28 outputs, to the exposure device 30, a control signal corresponding to a document image read in the image reading section 14 or corresponding to image information received from a personal computer, server, or the like (not shown) via a communication network. The exposure device 30 outputs a laser beam corresponding to the control signal.

The photoconductor 32 is driven and rotated when an image forming operation starts. A charging voltage is applied to the charging unit 34, and the charging unit 34 uniformly charges the surface of the photoconductor 32. An electrostatic latent image is formed on the surface of the charged photoconductor 32 with a laser beam. The electrostatic latent image on the photoconductor 32 is developed into a toner image by the developing device 36.

A sheet P is picked up by the pickup roller 42 in any of the paper feed trays 16A to 16D being used and is transported by the transporting part 44 to the transfer unit 38.

The transport device 60 transports the sheet P in synchronization with a transfer operation of the photoconductor 32 in the transfer unit 38.

More specifically, the sheet P is sent toward the photoconductor 32 at the timing when the print position set on the sheet P and the position of the toner image on the photoconductor 32 are aligned, so that the toner image and the sheet P face each other at the transfer position.

Then, the toner image on the photoconductor 32 is transferred to the sheet P.

The sheet P to which the toner image has been transferred is subjected to fixing processing in the fixing device 48 and is output on, for example, the paper output tray 52.

Referring to FIGS. 1 to 5, the first exemplary embodiment will be described.

As shown in FIG. 1, the transport device 60 is provided between the tray unit 16 and the transfer unit 38.

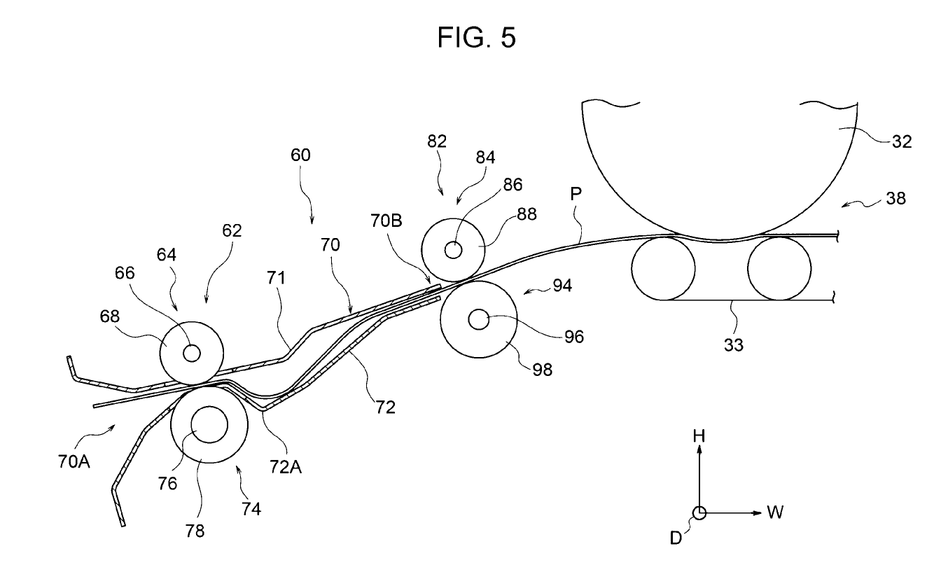

As shown in FIG. 5, the transport device 60 includes a first transporting part 62 and a second transporting part 82 that transport a sheet P. The distance between the first transporting part 62 and the second transporting part 82 is smaller than the length, in the sheet transport direction, of the smallest sheet P handled in the image forming apparatus 10. Hence, the first transporting part 62 and the second transporting part 82 transport one sheet P.

Furthermore, a guide unit 70 that guides the sheet P extends from the first transporting part to the second transporting part.

### First Transporting Part

As shown in FIG. 1, in the sheet transport path in the image forming section 12, the first transporting part 62 is located on the downstream side of the tray unit 16 and on the upstream side of the transfer unit 38 in the sheet transport direction.

As shown in FIG. 5, the first transporting part 62 includes a first rotation member 64, which is disposed above a transported sheet P in the apparatus height direction H, and a second rotation member 74, which is disposed below the first rotation member 64 in the apparatus height direction H so as to oppose and be in contact with the first rotation member 64.

The first rotation member 64 and the second rotation member 74 both extend in the direction perpendicular to the sheet transport direction.

### First Rotation Member

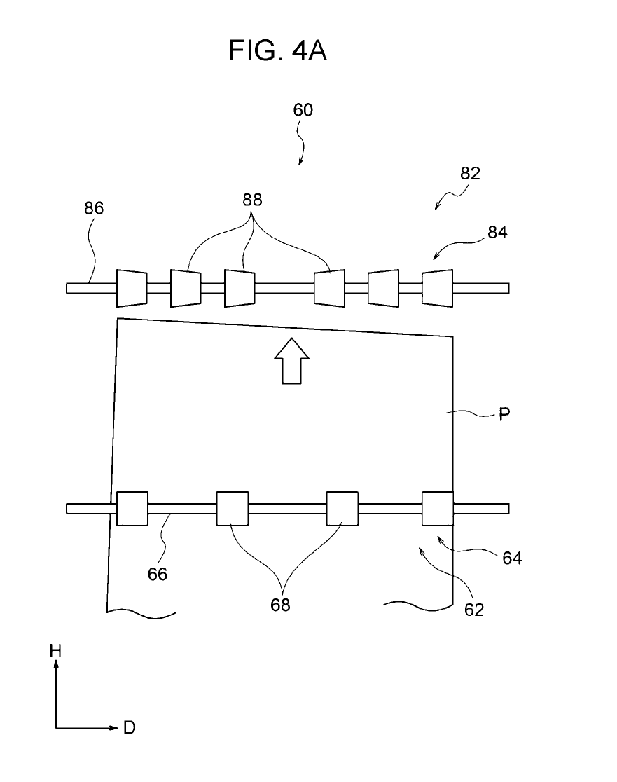

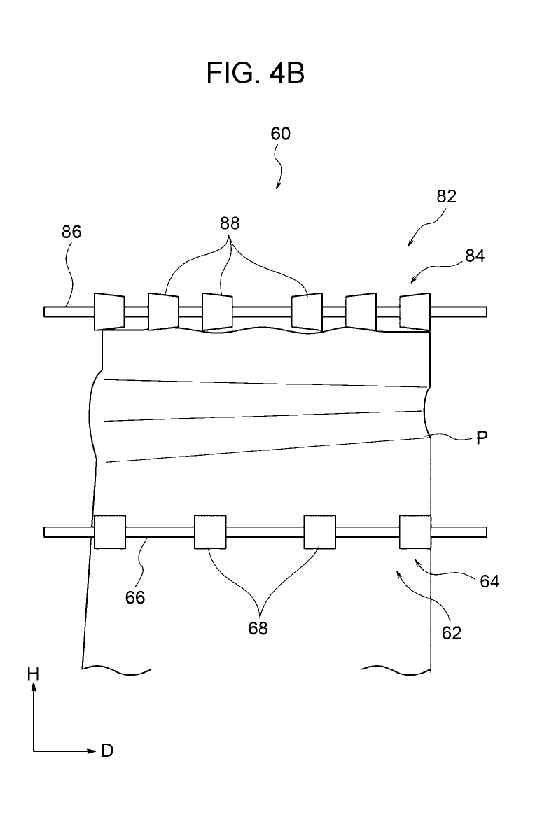

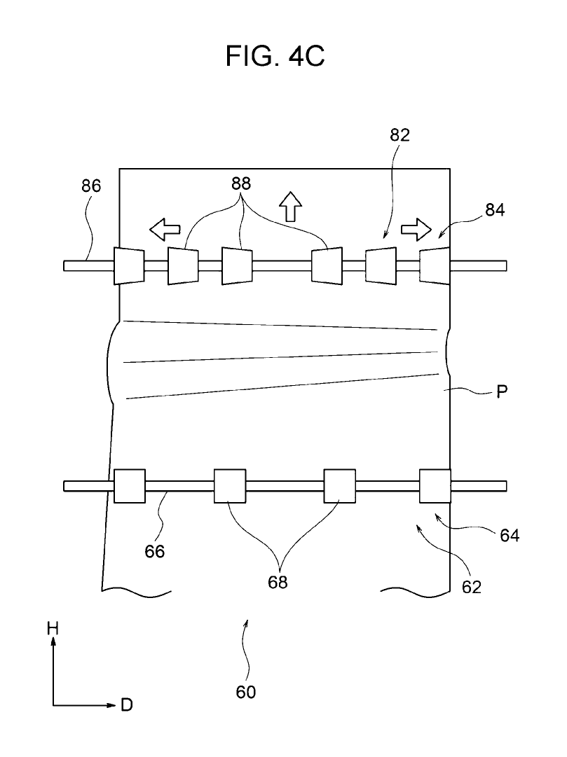

As shown in FIGS. 4A and 5, the first rotation member 64 includes a shaft 66 extending in the apparatus depth direction D and multiple (in this exemplary embodiment, four) cylindrical rollers 68 provided on the shaft 66 at intervals in the apparatus depth direction D.

### Second Rotation Member

As shown in FIG. 5, the second rotation member 74 includes a shaft 76 extending in the apparatus depth direction D and multiple (in this exemplary embodiment, four) cylindrical rollers 78 provided on the shaft 76 at intervals in the apparatus depth direction D. The rollers 78 are opposed to and in contact with the rollers 68 of the first rotation member 64.

The second rotation member 74 is connected to a driving device (not shown) and receives the supply of a driving force.

As has been described above, in the first transporting part 62, the rollers 68 of the first rotation member 64 are opposed to and in contact with the rollers 78 of the second rotation member 74, and the first rotation member 64 is rotated by the drivingly rotating second rotation member 74. The first transporting part 62 transports a sheet P transported from the tray unit 16 by the transporting part 44 toward the second transporting part 82 by nipping the sheet P between the first rotation member 64 and the second rotation member 74.

### Second Transporting Part

As shown in FIG. 1, the second transporting part 82 is located on the downstream side of the first transporting part 62 and on the upstream side of the transfer unit 38 in the sheet transport direction.

As show in FIG. 5, the second transporting part 82 includes a third rotation member 84, which is disposed above a transported sheet P in the apparatus height direction H, and a fourth rotation member 94, which is disposed below the third rotation member 84 in the apparatus height direction H so as to oppose and be in contact with the third rotation member 84.

The third rotation member 84 and the fourth rotation member 94 both extend in the direction parallel to the plane of the sheet P and perpendicular to the sheet transport direction.

### Third Rotation Member

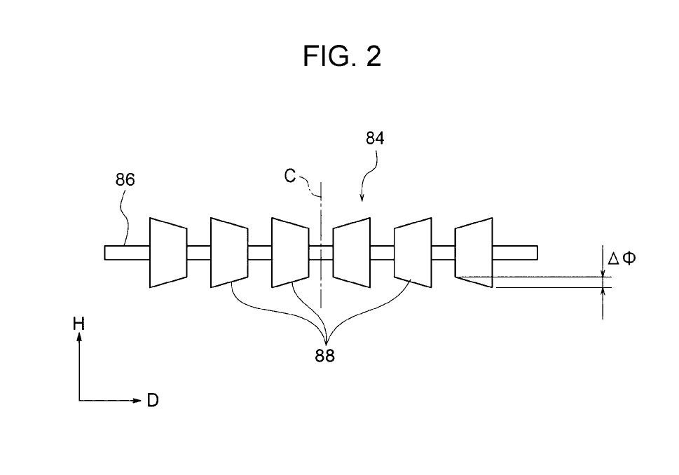

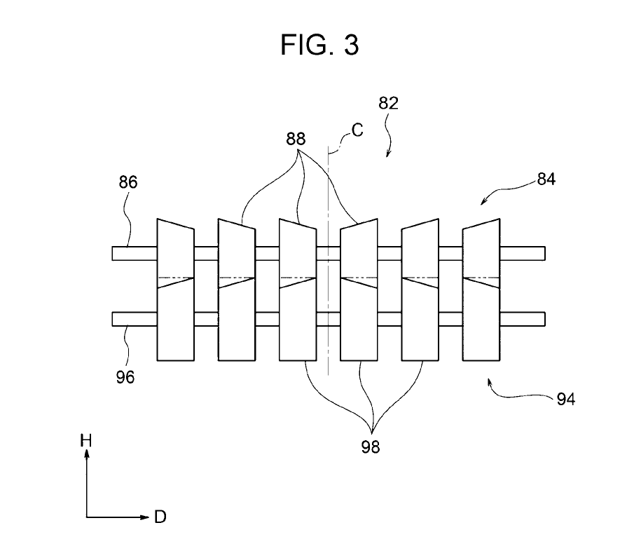

As shown in FIGS. 2 and 3, the third rotation member 84 includes a shaft 86 extending in the apparatus depth direction D and multiple (in this exemplary embodiment, six) rollers 88 provided on the shaft 86 at intervals in the apparatus depth direction D. The shaft 86 extends in the direction perpendicular to the sheet transport direction.

The rollers 88 are circular-truncated-cone-shaped rollers 88, in which the diameter φ of the base on one side is larger than the diameter φ of the base on the other side in the axial direction of the shaft 86.

The rollers 88 are an example of rotary members, and the third rotation member 84 is an example of one transport member.

In the third rotation member 84 in this exemplary embodiment, multiple circular-truncated-cone-shaped rollers 88 are provided so as to be oriented axially outward from the central position C, which is in the middle between the rollers 88 located at the extreme outside positions in the axial direction of the shaft 86. The circular-truncated-cone-shaped roller 88 are arranged such that the bases closer to the central position C have a smaller diameter. In other words, the slopes on the outer circumferential surfaces of the circular-truncated-cone-shaped rollers 88 are symmetrically arranged with respect to the central position C in the apparatus depth direction D.

The central position C is substantially aligned with the center of the sheet P in the transport width direction.

In this exemplary embodiment, in each circular-truncated-cone-shaped roller 88, the difference in diameter Δφ between the smaller base, which is closer to the central position C (hereinbelow, also referred to as “the inner side”), and the larger base, which is farther from the central position C (hereinbelow, also referred to as “the outer side”), is 1 mm. All the circular-truncated-cone-shaped rollers 88 have the same length in the axial direction.

The circular-truncated-cone-shaped rollers 88 are formed of a synthetic resin material. The hardness and elastic modulus of the rollers 88 are set such that the circular-truncated-cone shape, which has the slope, is maintained even when the rollers 88 are in contact with rollers 98 of the fourth rotation member 94.

The third rotation member 84 is urged against the fourth rotation member 94 by means of elastic force exerted by springs (not shown).

### Fourth Rotation Member

As shown in FIG. 3, the fourth rotation member 94 includes a shaft 96 extending in the apparatus depth direction D and multiple (in this exemplary embodiment, six) rollers 98 provided on the shaft 96 at intervals in the apparatus depth direction D. Similarly to the shaft 86 of the third rotation member 84, the shaft 96 also extends in the direction parallel to the plane of the sheet P and perpendicular to the sheet transport direction. The shaft 96 and the shaft 86 are parallel to each other.

The rollers 98 are cylindrical, that is, the outer circumferential surfaces of the rollers 98 are parallel to the axial direction of the shaft 96. The rollers 98 are in contact with the circular-truncated-cone-shaped rollers 88 of the third rotation member 84.

The fourth rotation member 94 is connected to a driving device (not shown) and receives the supply of a driving force.

The rollers 98 are an example of rotary members, and the fourth rotation member 94 is an example of another transport member.

The rollers 98 are formed of a synthetic resin material that has lower hardness and that resists more when restored to the original shape than the circular-truncated-cone-shaped rollers 88 of the third rotation member 84.

Hence, outer-circumferential-surface portions of the rollers 98 that are in contact with the circular-truncated-cone-shaped rollers 88 are pressed by the outer circumferential surfaces of the circular-truncated-cone-shaped rollers 88 and are elastically deformed in the shape conforming to the outer circumferential surfaces of the circular-truncated-cone-shaped rollers 88.

As has been described above, in the second transporting part 82, the circular-truncated-cone-shaped rollers 88 of the third rotation member 84 and the rollers 98 of the fourth rotation member 94 are opposed to and in contact with each other, and the third rotation member 84 is rotated by the drivingly rotating fourth rotation member 94. The second transporting part 82 temporarily stops a sheet P transported by the first transporting part 62 by receiving the leading end of the sheet P with the third rotation member 84 and the fourth rotation member 94 that are stopped. Thereafter, the third rotation member 84 and the fourth rotation member 94 are rotated to nip and transport the sheet P. Driving and control of the second transporting part 82 will be described below.

### Guide Unit

As shown in FIG. 5, the guide unit 70 includes a pair of guide plates, namely, a first guide plate 71, which guides the upper side of a sheet P being transported, and a second guide plate 72, which guides the lower side of the sheet P.

The guide unit 70 is provided in an area between the upstream side of the first transporting part 62 and the upstream side of the second transporting part 82 in the sheet transport direction, which is in front of a portion where the third rotation member 84 and the fourth rotation member 94 are in contact with each other, so as to extend through the first transporting part 62.

More specifically, the guide unit 70 has, on the upstream side of the first transporting part 62, an inlet 70A from which the sheet P transported from the tray unit 16 by the transporting part 44 is received. The guide unit 70 continuously narrows from the inlet 70A toward a portion where the first rotation member 64 and the second rotation member 74 are in contact with each other.

The guide unit 70 has a large-space portion between the first transporting part 62 and the second transporting part 82. The large-space portion has a space enough to allow the sheet P transported therein to temporarily sag and is formed by providing a bent portion 72A protruding downward in the second guide plate 72.

The space in the guide unit 70 gradually decreases from the bent portion 72A and has, in front of the second transporting part 82, an outlet 70B from which the sheet P is output.

As has been described above, in the guide unit 70, the first guide plate 71 and the second guide plate 72 face each other and extend from the inlet 70A to the outlet 70B via the bent portion 72A.

The function of the bent portion 72A will be described below.

The effect of this exemplary embodiment will be described with reference to FIGS. 1 to 5, while comparing with Comparison Example 1.

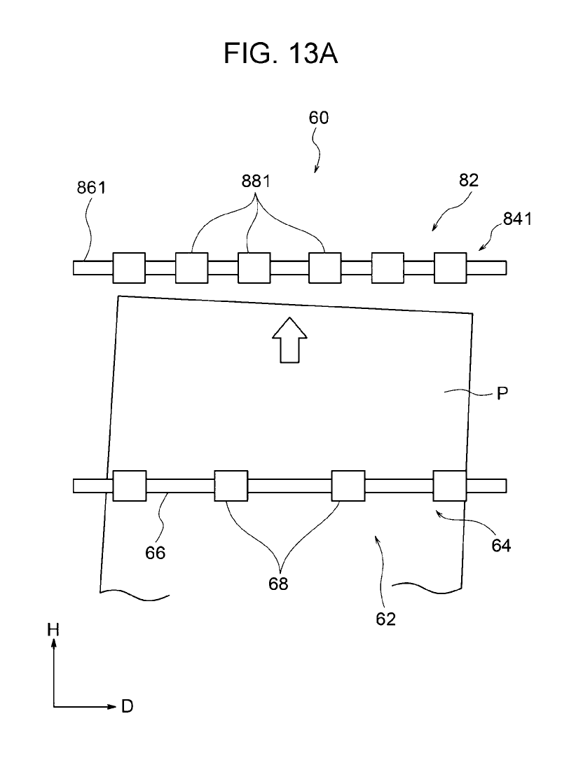

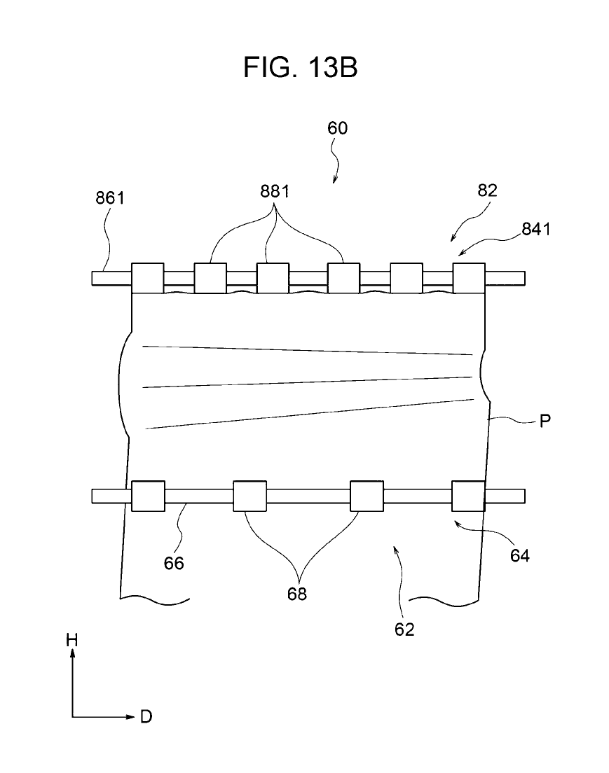

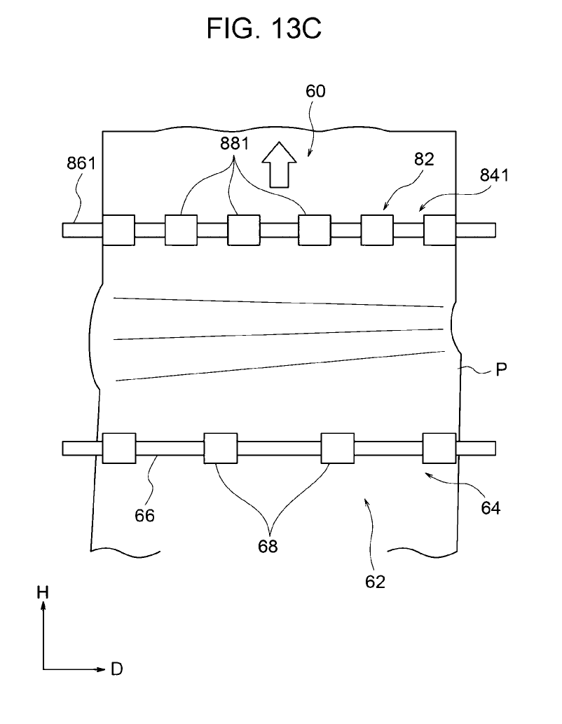

First, in Comparison Example 1, as shown in FIG. 13A, a third rotation member 841 of the second transporting part 82 includes a shaft 861 and cylindrical rollers 881, whose outer circumferential surfaces are parallel to the shaft 861.

The fourth rotation member 94 is provided below the third rotation member 841 so as to be opposed thereto. The rollers 881 and the rollers 98 are in contact with each other and are stopped (see FIG. 5).

A sheet P transported by the first transporting part 62 is obliquely transported toward the second transporting part 82, and the leading end of the sheet P comes into contact with the stopped rollers 881 and 98 and stops, as shown in FIG. 13B.

At the leading-end section of the sheet P in contact with the rollers 881 and 98, a portion located in a space where the rollers 881 and 98 are not provided, that is, a portion not in contact with the rollers 881 and 98, undulates up and down in the apparatus height direction H.

At this time, a portion of the leading-end-section of the sheet P, the portion adjacent to the portion in contact with the rollers 881 and 98, undulates in the apparatus height direction H, that is, in the top-bottom direction. This is obvious when thin sheets P are used.

As shown in FIG. 13C, the undulating sheet P starts to be transported by the second transporting part 82 in accordance with the timing at which an image is transferred in the transfer unit 38 (see FIG. 5), that is, the sheet P is transported toward the transfer unit 38 by the third rotation member 881 and the fourth rotation member 98.

At this time, the leading-end-section of the sheet P having passed below the rollers 881, which have the outer circumferential surfaces parallel to the shaft 861, is transported to the photoconductor 32 in the transfer unit 38 without the undulation corrected.

As a result, a toner image is not appropriately transferred from the photoconductor 32 to a sheet P in the transfer unit 38, resulting in output image defects.

Furthermore, the sheet P may be creased due to undulation, also resulting in output image defects.

In contrast, in this exemplary embodiment, as shown in FIGS. 4A and 5, a sheet P is fed into the transport device 60 from the inlet 70A of the guide unit 70 and is transported toward the second transporting part 82 while being nipped between the first rotation member 64 and the second rotation member 74 of the first transporting part 62.

At this time, the third rotation member 84 and the fourth rotation member 94 in the second transporting part 82 are not rotating.

Then, as shown in FIG. 4B, the leading end of the sheet P transported by the first transporting part 62 comes into contact with the portion where the circular-truncated-cone-shaped rollers 88 of the third rotation member 84 and the rollers 98 of the fourth rotation member 94 in the second transporting part 82, which are not rotating, are in contact with each other. Thus, the sheet P stops at the second transporting part 82.

While the sheet P stops at the second transporting part 82, the first transporting part 62 continues to transport the sheet P. Hence, as shown in FIG. 5, the sheet P sags along the bent portion 72A of the guide unit 70.

As shown in FIG. 4C, the third rotation member 84 of the second transporting part 82 has the circular-truncated-cone-shaped rollers 88.

When the sheet P starts to be transported in the second transporting part 82, the circular-truncated-cone-shaped rollers 88 of the third rotation member 84 transport the sheet P while pulling the sheet P toward the large-diameter side of the circular-truncated-cone-shaped rollers 88, that is, in the direction perpendicular to the sheet transport direction.

In this exemplary embodiment, the sheet P is transported while being pulled outward in the axial direction by the multiple circular-truncated-cone-shaped rollers 88 that are provided so as to be oriented axially outward from the central position C, which is in the middle between the rollers 88 located at the extreme outside positions in the axial direction of the shaft 86 in the third rotation member 84.

As a result, the up-and-down undulation of the sheet P is eliminated, or the amplitude of the undulation is reduced, and the leading-end section of the sheet P becomes substantially flat. Creases in the sheet P due to undulation are also eliminated or reduced.

The first transporting part 62 and the second transporting part 82 feed the sheet P having no or reduced undulation at the leading-end section to the transfer unit 38.

This configuration reduces output image defects because a toner image formed on the photoconductor 32 is properly transferred to a flat sheet P, which has no undulation, in the transfer unit 38.

As described above, in this exemplary embodiment, the transport device 60 includes, to transport a sheet P, the first transporting part 62 and a pair of rotation members 84 and 94, which have the shafts 86 and 96 on which multiple rollers 88 and 98 are arranged at intervals in the axial direction.

The transport device 60 also includes the second transporting part 82, which transports the sheet P while nipping the sheet P between the third rotation member 84 and the fourth rotation member 94 after the leading end of the sheet P transported by the first transporting part 62 comes into contact with the third rotation member 84 and the fourth rotation member 94. In the second transporting part 82, at least one of the rollers 88 of the third rotation member 84 is the circular-truncated-cone-shaped roller 88, in which the diameter φ on one side is larger than the diameter φ on the other side in the axial direction.

With this configuration, in the second transporting part 82, the sheet P is transported while being pulled toward the large-diameter side of the circular-truncated-cone-shaped rollers 88.

In the transport device 60, multiple circular-truncated-cone-shaped rollers 88 are provided so as to be oriented axially outward from the central position C, which is in the middle between the rollers 88 located at the extreme outside positions in the axial direction of the shaft 86. In each circular-truncated-cone-shaped roller 88, the diameter of the base closer to the central position C is smaller.

This configuration reduces undulation of the sheet P, compared with a structure in which all the circular-truncated-cone-shaped rollers 88 are oriented in the same direction.

The image forming apparatus 10 includes the transfer unit 38 for transferring a toner image to a sheet P, and the transport device 60 disposed on the upstream side of the transfer unit 38 in the sheet transport direction.

This configuration reduces output image defects, compared with a structure in which the image forming apparatus 10 does not have the transport device 60.

### Modification 1

In Modification 1, the configuration of the circular-truncated-cone-shaped rollers 88 provided in the third rotation member 84 according to this exemplary embodiment, which is shown in FIG. 2, is partially changed.

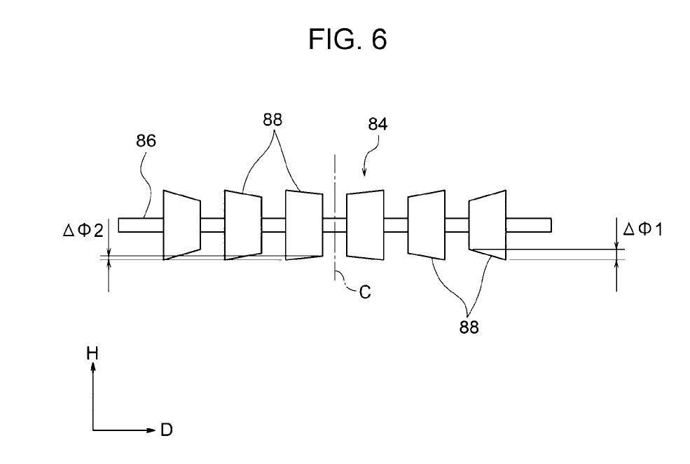

As shown in FIG. 6, in the third rotation member 84 in Modification 1, the difference in diameter between the base on one side and the base on the other side in the circular-truncated-cone-shaped rollers 88 located at the extreme outside positions is larger than that in the circular-truncated-cone-shaped rollers 88 located closer to the central position C.

More specifically, the difference in diameter Δα1 between the inner-side base and the outer-side base of the circular-truncated-cone-shaped rollers 88 located farther from the central position C (i.e., located at the extreme outside positions in the third rotation member 84) is greater than the difference in diameter Δφ2 between the inner-side base and the outer-side base of the circular-truncated-cone-shaped rollers 88 located closer to the central position C.

In this modification, in the multiple circular-truncated-cone-shaped rollers 88, the diameters of the outer-side bases are larger than the diameters of the inner-side bases. The diameters of the outer-side bases (larger diameters) of the circular-truncated-cone-shaped rollers 88 are equal. The diameters of the inner-side bases (smaller diameters) of the circular-truncated-cone-shaped rollers 88 become smaller as the positions of the circular-truncated-cone-shaped rollers 88 are farther from the central position C.

All the circular-truncated-cone-shaped rollers 88 have the same length in the axial direction.

Hence, the inclinations of the outer circumferential surfaces of the multiple circular-truncated-cone-shaped rollers 88 become larger as the positions of the circular-truncated-cone-shaped rollers 88 are farther from the central position C.

This configuration reduces undulation of a sheet P, compared with a configuration in which the difference in diameter between the inner-side base and the outer-side base is uniform in all the circular-truncated-cone-shaped rollers 88. Furthermore, occurrence of creases in the sheet P is reduced.

### Second Exemplary Embodiment

### Configuration of Second Exemplary Embodiment

Next, a second exemplary embodiment will be described. In the second exemplary embodiment, components having the same configurations as those in the first exemplary embodiment will be denoted by the same reference signs, and descriptions thereof will be omitted.

The transport device 60 in the second exemplary embodiment includes, instead of the third rotation member 84 of the second transporting part 82 in the first exemplary embodiment, a third rotation member 104 including a cylindrical roller 110.

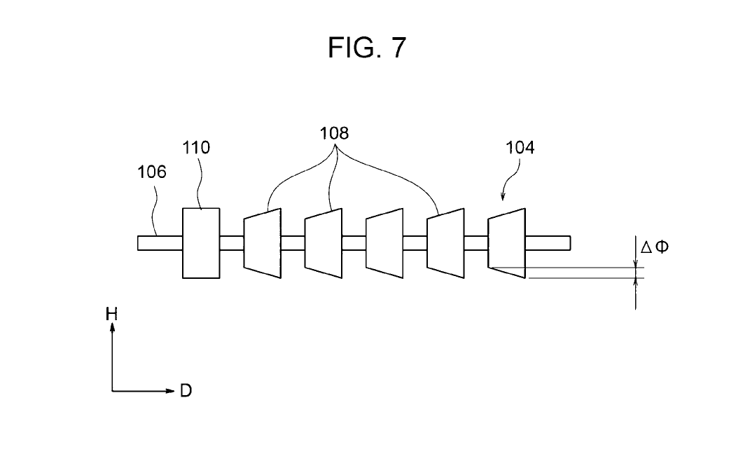

As shown in FIG. 7, the third rotation member 104 includes a shaft 106, the cylindrical roller 110, whose outer circumferential surface is a cylindrical surface parallel to the shaft 106, and multiple circular-truncated-cone-shaped rollers 108 disposed at a certain distance from the cylindrical roller 110.

The cylindrical roller 110 is disposed on the shaft 106, on the far side (i.e., the left side in FIG. 7) in the apparatus depth direction D.

The multiple circular-truncated-cone-shaped rollers 108 are arranged at intervals so as to be oriented from the cylindrical roller 110 side toward the near side (i.e., the right side in FIG. 7) in the apparatus depth direction D.

The inclination of the outer circumferential surface of each circular-truncated-cone-shaped roller 108 is formed by making the base farther from the cylindrical roller 110 have a larger diameter than the base closer to the cylindrical roller 110 in the axial direction.

The cylindrical roller 110 is an example of a cylindrical rotary member, and the third rotation member 104 is an example of a one transport member.

In this exemplary embodiment, in each circular-truncated-cone-shaped roller 108, the difference in diameter Δφ between the smaller base, which is closer to the cylindrical roller 110, and the larger base, which is farther from the cylindrical roller 110, is 1 mm.

The circular-truncated-cone-shaped rollers 108 are formed of a synthetic resin material. The hardness thereof is set such that the circular-truncated-cone shape, which has the inclination, is maintained even when the circular-truncated-cone-shaped rollers 108 are in contact with the rollers 98 of the fourth rotation member 94.

In this exemplary embodiment, the diameter of the cylindrical roller 110 is larger than the diameters of the bases of the circular-truncated-cone-shaped rollers 108 closer to the cylindrical roller 110 and is smaller than the diameters of the bases of the circular-truncated-cone-shaped rollers 108 farther from the cylindrical roller 110.

This configuration allows the contact between the inclined outer circumferential surfaces of the circular-truncated-cone-shaped rollers 108 and the outer circumferential surfaces of the rollers 98 to be maintained when the cylindrical roller 110 is in contact with the roller 98 of the fourth rotation member 94 facing the cylindrical roller 110.

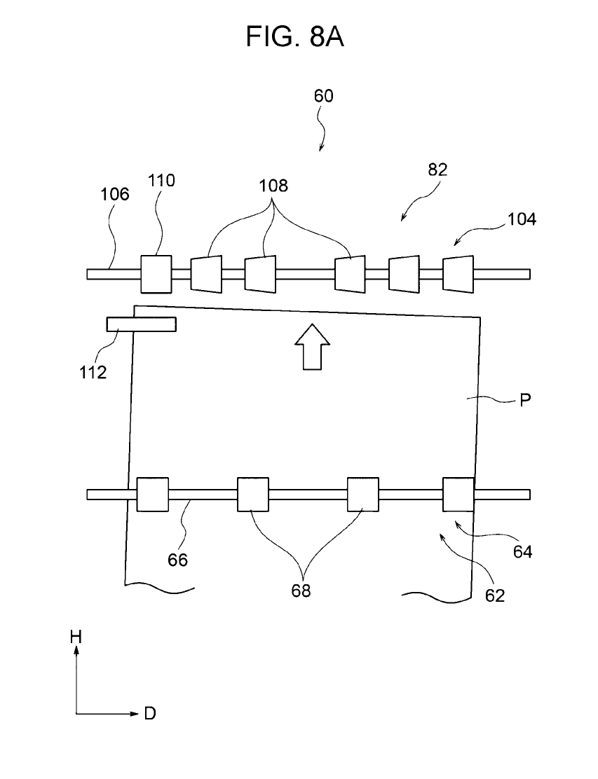

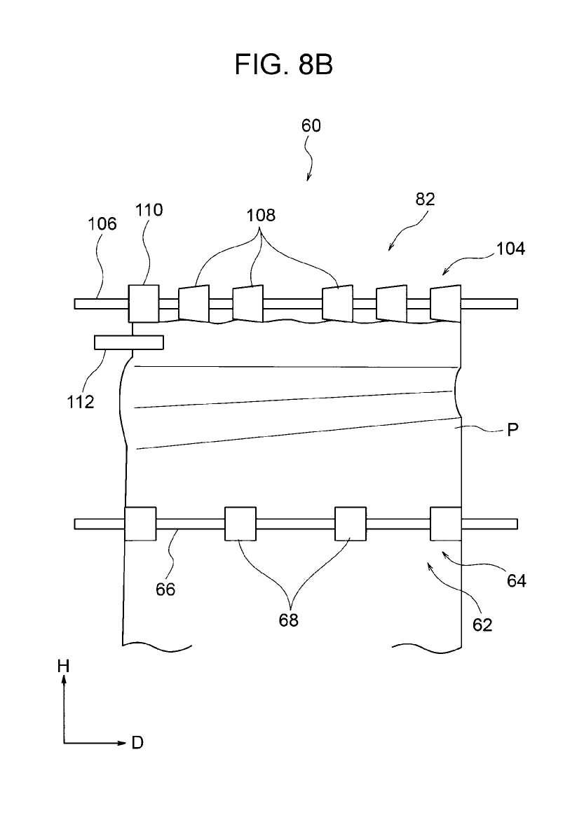

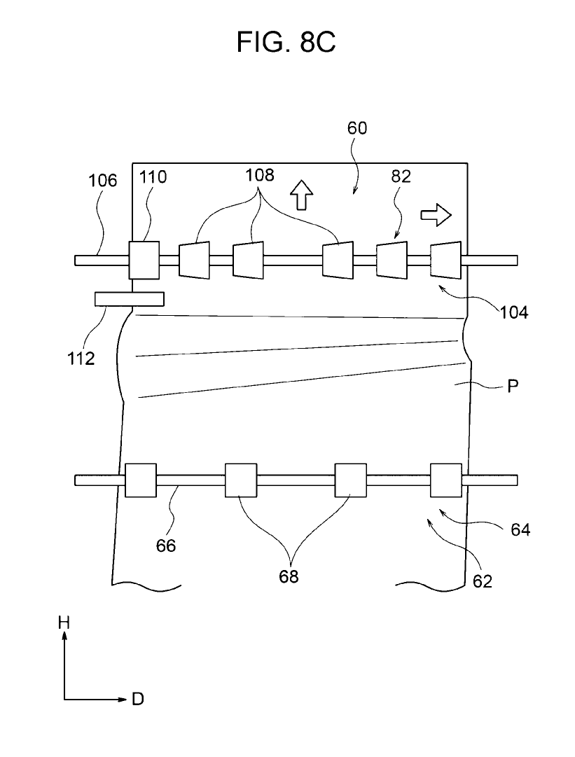

As shown in FIG. 8A, a sheet detecting device 112 is provided on the upstream side of the cylindrical roller 110 in the sheet transport direction to detect the position of the far side end, in the apparatus depth direction, of a sheet P that is being transported. The sheet detecting device 112 includes multiple light-projecting/receiving photoelectric tubes (not shown) and detects the far-side end of the transported sheet P without touching the sheet P.

The sheet detecting device 112 is an example of a medium-position detecting device.

### Effect of Second Exemplary Embodiment

The effect of this exemplary embodiment compared with Comparison Example 2 will be described with reference to FIGS. 8A to 8C.

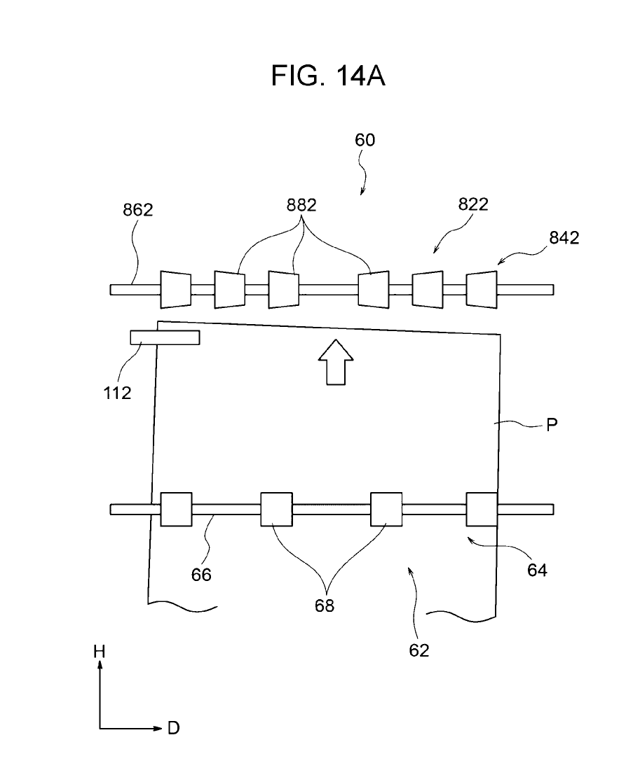

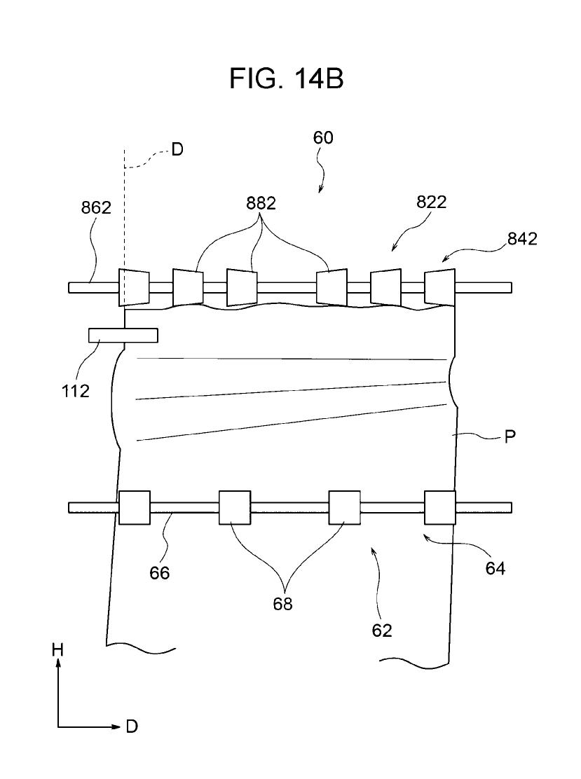

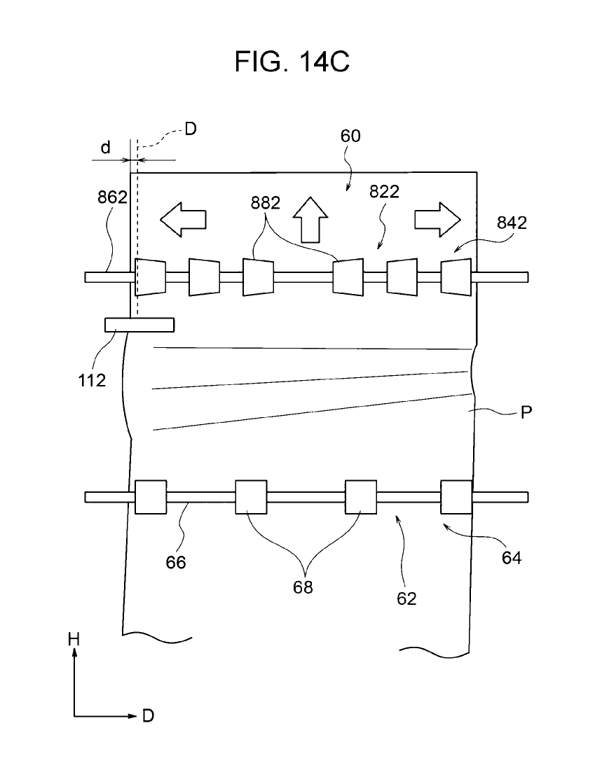

First, in Comparison Example 2, as shown in FIG. 14A, multiple circular-truncated-cone-shaped rollers 882 are provided in a third rotation member 842 of a second transporting part 822 so as to be oriented axially outward from the central position C, which is in the middle between the rollers 882 located at the extreme outside positions in the axial direction of the shaft 862. The circular-truncated-cone-shaped roller 882 are arranged such that the bases closer to the central position C have a smaller diameter. In other words, the slopes on the outer circumferential surfaces of the circular-truncated-cone-shaped rollers 882 are symmetrically arranged with respect to the central position C in the apparatus depth direction D.

Furthermore, the fourth rotation member 94 is provided below the third rotation member 842 so as to oppose the third rotation member 842. The circular-truncated-cone-shaped rollers 882 and the rollers 98 are in contact with each other and are stopped (see FIG. 5).

A sheet P transported by the first transporting part 62 is obliquely transported toward the second transporting part 822, and the leading end of the sheet P comes into contact with the stopped rollers 882 and 98 and stops, as shown in FIG. 14B.

At this time, the far-side end (i.e., the left-side end in FIG. 14B) of the sheet P in the apparatus depth direction D is located at a position indicated by a dashed line D. The sheet detecting device 112 detects the position of the far-side end of the sheet P and transmits the information to the controller 28 in FIG. 1.

At the leading-end section of the sheet P in contact with the rollers 882 and 98, a portion located in a space where the rollers 882 and 98 are not provided, that is, a portion not in contact with the rollers 882 and 98 undulates up and down in the apparatus height direction H.

As shown in FIG. 14C, the undulating sheet P is transported while being pulled toward the large-diameter side of the circular-truncated-cone-shaped rollers 882 by the circular-truncated-cone-shaped rollers 882. Thus, the undulation of the sheet P is eliminated or reduced.

However, because the sheet P is pulled outward in the axial direction of the shaft 862 of the third rotation member 842 by the circular-truncated-cone-shaped rollers 882, the far-side end of the sheet P is shifted to the far side from the dashed line D by dimension d.

The second transporting part 822 starts to transport the sheet P in accordance with the timing at which an image is transferred by the transfer unit 38 (see FIG. 5), and the third rotation member 882 and the fourth rotation member 94 transport the sheet P toward the transfer unit 38.

At this time, the controller 28 controls the image forming position on the photoconductor 32 in the transfer unit 38 on the basis of the detection information transmitted by the sheet detecting device 112, indicating that the far-side end of the sheet P is located at the position indicated by the dashed line D. However, the actual position of the far-side end of the sheet P is shifted from the position indicated by the dashed line D by dimension d during transportation.

Hence, in the transfer unit 38, the toner image transferred from the photoconductor 32 to the sheet P may be shifted by dimension d, leading to output image defects.

In contrast, in the second exemplary embodiment, as shown in FIG. 8A, the third rotation member 104 includes the cylindrical roller 110 having an outer circumferential surface that is parallel to the axial direction of the shaft 106, on the far side (i.e., the left side in FIG. 8A) in the apparatus depth direction D. Furthermore, the circular-truncated-cone-shaped rollers 108 are provided at intervals so as to be oriented from the cylindrical roller 110 side toward the side farther from the cylindrical roller 110. The inclination of the outer circumferential surface of each circular-truncated-cone-shaped roller 108 is formed by making the base farther from the cylindrical roller 110 have a larger diameter than the base closer to the cylindrical roller 110 in the axial direction.

Furthermore, the sheet detecting device 112 for detecting the position of the sheet P in the direction perpendicular to the sheet transport direction is provided on the downstream side of the first transporting part 62 and on the upstream side of the cylindrical roller 110 in the sheet transport direction.

The sheet detecting device 112 has the same function as that of the sheet detecting device 112 in Comparison Example 2 and transmits the detected position of the sheet P to the controller 28.

With this configuration, as shown in FIGS. 8E and 8C, the sheet P is transported through the second transporting part 82 by the cylindrical roller 110, which is provided on the far side in the apparatus depth direction D, while shifting of the far-side end thereof in the transport width direction is prevented. In other words, as shown in FIG. 8C, the sheet P is transported through the second transporting part 82 while the position of the far-side end of the sheet P in contact with the second transporting part 82, as shown in FIG. 8B, which is detected by the sheet detecting device 112, is maintained.

As a result, the up-and-down undulation of the sheet P is eliminated, or the amplitude of the undulation is reduced, and the leading-end section of the sheet P becomes substantially flat. Creases in the sheet P due to undulation are also eliminated or reduced.

As a result, in the transfer unit 38, the toner image on the photoconductor 32 is transferred to the sheet P without being shifted in the transport width direction, on the basis of the information about the position of the far-side end of the sheet P detected by the sheet detecting device 112.

This configuration reduces output image defects.

As has been described above, the second exemplary embodiment reduces shifting of the transported sheet P in the direction perpendicular to the sheet transport direction, compared with a configuration in which all the rollers in the third rotation member 104 are circular-truncated-cone-shaped rollers 108.

Furthermore, in the configuration in which the position of the sheet P is detected by the sheet detecting device 112, error in detecting the position of the transported sheet P is reduced, compared with a configuration in which all the rotary members are circular-truncated-cone-shaped rollers 108.

### Modification 2

In Modification 2, the configuration of the circular-truncated-cone-shaped rollers 108 in the third rotation member 104 according to the exemplary embodiments, shown in FIG. 7, is partially changed.

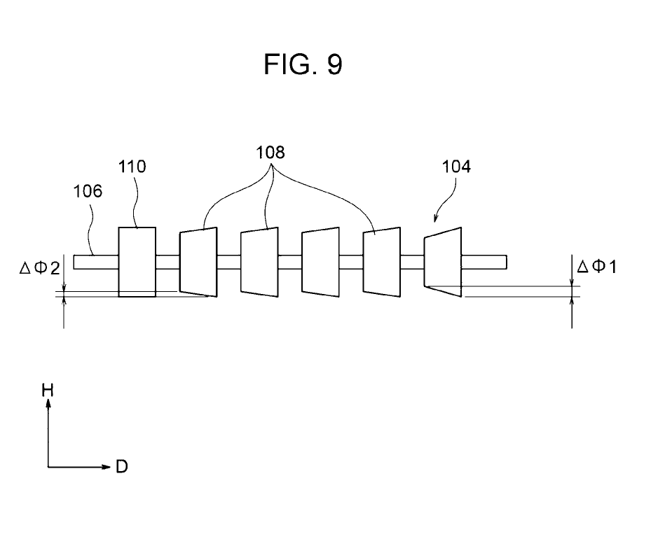

As shown in FIG. 9, in the third rotation member 104 in Modification 2, the inclinations of the outer circumferential surfaces of the circular-truncated-cone-shaped rollers 108 become larger from the side closer to the cylindrical roller 110 to the side farther from the cylindrical roller 110.

More specifically, the difference in diameter Δφ2 between the base closer to the cylindrical roller 110 and the base farther from the cylindrical roller 110 in the circular-truncated-cone-shaped roller 108 closer to the cylindrical roller 110 gradually increases toward the difference in diameter Δφ1 between the base closer to the cylindrical roller 110 and the base farther from the cylindrical roller 110 in the circular-truncated-cone-shaped roller 108 farther from the cylindrical roller 110.

Specifically, in the third rotation member 104 in Modification 2, a large number (five) of circular-truncated-cone-shaped rollers 108, which are inclined in the same direction, are provided so as to be oriented from the side closer to the cylindrical roller 110 to the side farther from the cylindrical roller 110.

In the case where the circular-truncated-cone-shaped rollers 108 oriented from the side closer to the cylindrical roller 110 to the side farther from the cylindrical roller 110 are inclined in the same direction, undulation of the sheet P that has been eliminated or reduced on the side closer to the cylindrical roller 110 may shift toward the side farther from the cylindrical roller 110 and may be unable to be sufficiently eliminated or reduced.

However, because the third rotation member 104 has five circular-truncated-cone-shaped rollers 108 whose outer circumferential surfaces have inclinations gradually increasing from the side closer to the cylindrical roller 110 to the side farther from the cylindrical roller 110, the sheet P is transported while being pulled toward the side farther from the cylindrical roller 110.

This configuration reduces undulation of sheets P, compared with a configuration in which all the outer circumferential surfaces of the circular-truncated-cone-shaped rollers 108 have the same inclination. Furthermore, occurrence of creases due to undulation of a sheet P is reduced.

### Third Exemplary Embodiment

### Configuration of Third Exemplary Embodiment

The transport device 60 according to the third exemplary embodiment includes a moving mechanism 120 that moves the third rotation member 84 and a fourth rotation member 94, which is provided opposite the third rotation member 84, toward and away from each other.

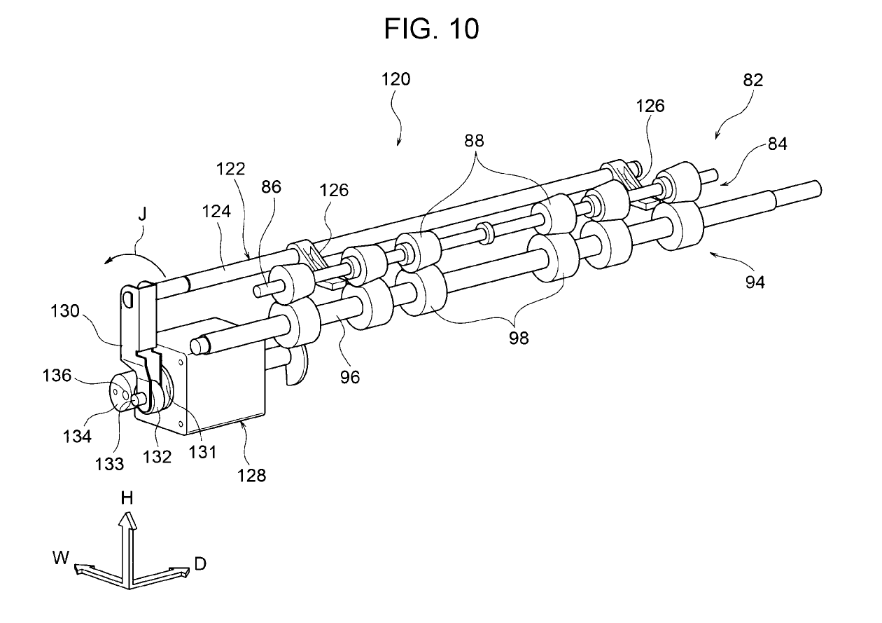

In this exemplary embodiment, as shown in FIG. 10, the moving mechanism 120 is provided in the second transporting part 82 so as to extend in the axial direction of the shaft 86 of the third rotation member 84 and moves the third rotation member 84 toward and away from the fourth rotation member 94.

The shaft 86 of the third rotation member 84 is fitted in guide grooves (not shown) extending in the apparatus height direction H so as to be capable of moving up and down.

The moving mechanism 120 includes working parts 122 that moves the third rotation member 84 toward and away from the fourth rotation member 94, and driving parts 128 that rotate the working part 122 in the apparatus width direction W.

### Working Part

The working part 122 includes a working shaft 124 provided parallel to and beside the shaft 86 of the third rotation member 84 in the apparatus width direction W.

Two working hooks 126 that are in contact with the lower outer circumferential surface of the shaft 86 in the apparatus height direction H are fixed to the working shaft 124 in a non-rotatable manner, at positions on the inner side of the circular-truncated-cone-shaped rollers 88 fixed at the extreme outside positions in the third rotation member 84 in the axial direction of the shaft 86 (apparatus depth direction D).

The working hooks 126 extend in the apparatus width direction W. Ends closer to the shaft 86, which are the ends opposite to the ends fixed to the working shaft 124, are the distal ends. The top surfaces of the distal ends in the apparatus height direction H are in contact with the lower outer circumferential surface of the shaft 86.

Working rods 130 connected to the driving parts 128 are fixed to the ends of the working shaft 124.

### Driving Part

The driving parts 128 each include a shaft 136 connected to a geared motor (not shown) and a cam 134 fixed to the shaft 136 in a non-rotatable manner.

The driving parts 128 also each include a circular working plate 132 that is in contact with and follows the cam 134, and the working rod 130 supported by a shaft 133 supporting the working plate 132 so as to be rotatable and extending upward in the apparatus height direction H.

The shaft 133 supporting the working plate 132 so as to be rotatable is eccentrically fixed to a shaft of a pivot plate 131 that is supported by a shaft (not shown) so as to be rotatable.

The ends of the working shaft 124 are fixed to the upper ends of the working rods 130 in a non-rotatable manner.

The lower ends of the working rods 130 are rotatably supported by the shafts 133, which support the working plate 132.

FIG. 10 shows the configuration of the driving part 128 and the working rod 130 on the near side in the apparatus depth direction D, and the illustration of those on the other side is omitted.

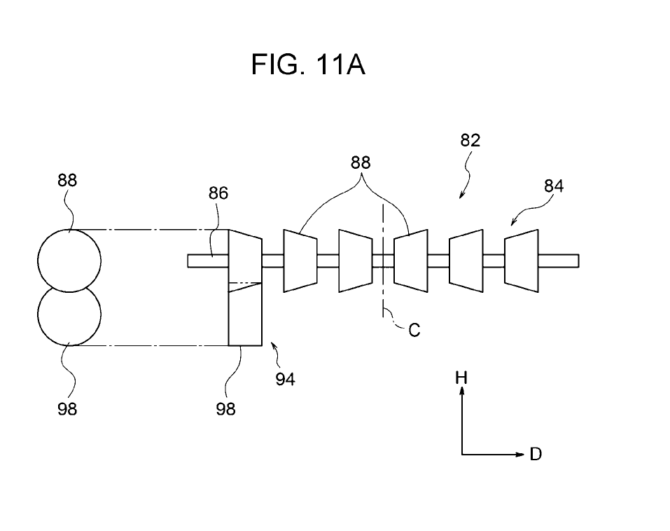

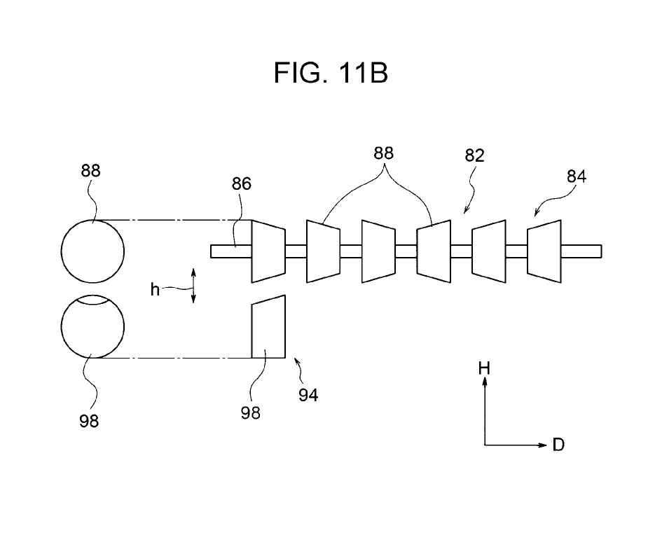

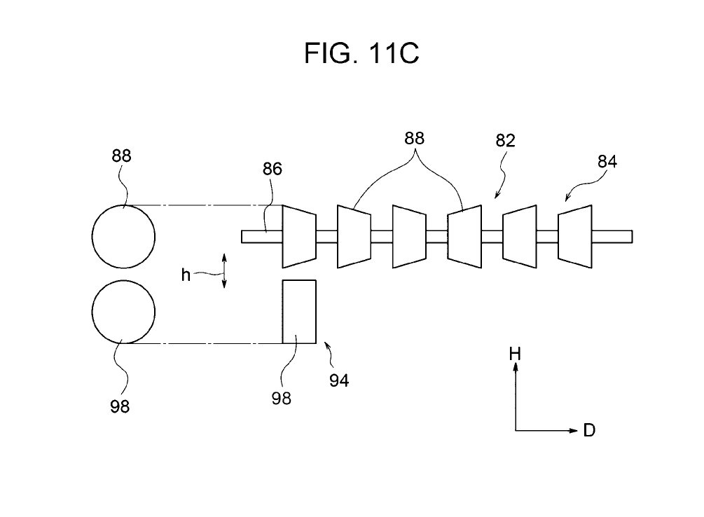

FIG. 11A is a side view of the second transporting part 82 in this exemplary embodiment, as viewed in the apparatus width direction W.

The configuration of and the contact state between the third rotation member 84 and the fourth rotation member 94 (FIG. 11A shows the roller 98 alone) in this exemplary embodiment are the same as those of the third rotation member 84 and the fourth rotation member 94 in the first exemplary embodiment.

### Effect of Third Exemplary Embodiment

The effect of the third exemplary embodiment will be described with reference to FIGS. 10 to 11C, while comparing with Comparison Example 3.

As shown in FIG. 10, in the second transporting part 82, the shafts 133 supporting the working rods 130 are located in the lower part of the pivot plates 131 due to the effect of the cams 134, and the working rods 130, which have been rotated in the direction opposite to the direction indicated by arrow J, stand substantially vertically. At this time, the top surfaces of the distal ends of the working hooks 126, fixed to the working shaft 124, are separated from the lower outer circumferential surface of the shaft 86 of the third rotation member 84.

In this state, the circular-truncated-cone-shaped rollers 88 of the third rotation member 84 are urged against the rollers 98 of the fourth rotation member 94.

In this state, as shown in FIG. 11A, the outer circumferential surfaces of the circular-truncated-cone-shaped rollers 88 press the outer circumferential surfaces of the rollers 98, deforming the outer circumferential surfaces of the rollers 98 (contact portions) in shapes conforming to the outer circumferential surfaces of the circular-truncated-cone-shaped rollers 88.

If this state lasts for a long time or a long term, deformation caused by being pressed by the outer circumferential surfaces of the circular-truncated-cone-shaped rollers 88 remains in the outer circumferential surfaces of the rollers 98, as in Comparison Example 3 shown in FIG. 11B, even after the circular-truncated-cone-shaped rollers 88 and the rollers 98 are separated from each other in the arrow h direction.

This is because the shape of the rollers 98, which are formed of a synthetic resin material that has lower hardness and that resists more when restored to the original shape than the circular-truncated-cone-shaped rollers 88, is less likely to be restored even the long-term pressing by the circular-truncated-cone-shaped rollers 88 is stopped.

In contrast, in this exemplary embodiment, the moving mechanism 120 moves the third rotation member 84 away from the fourth rotation member 94.

More specifically, the driving parts 128 shown in FIG. 10 rotate the cams 134, causing the working plates 132 to pivot to the middle of the pivot plates 131 in the apparatus height direction H, to the near side in the apparatus width direction W on the plane of the sheet of FIG. 10.

As a result, the working rods 130 rotate in the arrow J direction about shafts (not shown) provided on the pivot plates 131, moving the distal ends of the working hooks 126, fixed to the working shaft 124, upward in the apparatus height direction H.

As a result, the shaft 86 of the third rotation member 84 is pushed up in the apparatus height direction H by the top surfaces of the distal ends of the working hooks 126, thus moving upward along the guide grooves (not shown), and the circular-truncated-cone-shaped rollers 88 of the third rotation member 84 are separated from the rollers 98 of the fourth rotation member 94.

This operation is controlled by the controller 28.

In the image forming apparatus 10, the third rotation member 84 and the fourth rotation member 94 are separated after a sheet P leaves the second transporting part 82 (i.e., passes through third rotation member 84 and the fourth rotation member 94) and before a subsequent sheet P is transported to the first transporting part 62.

The third rotation member 84 and the fourth rotation member 94 are brought into contact with each other after the subsequent sheet P starts to be transported to the first transporting part 62 and before the subsequent sheet P leaves (has passed through) the second transporting part 82.

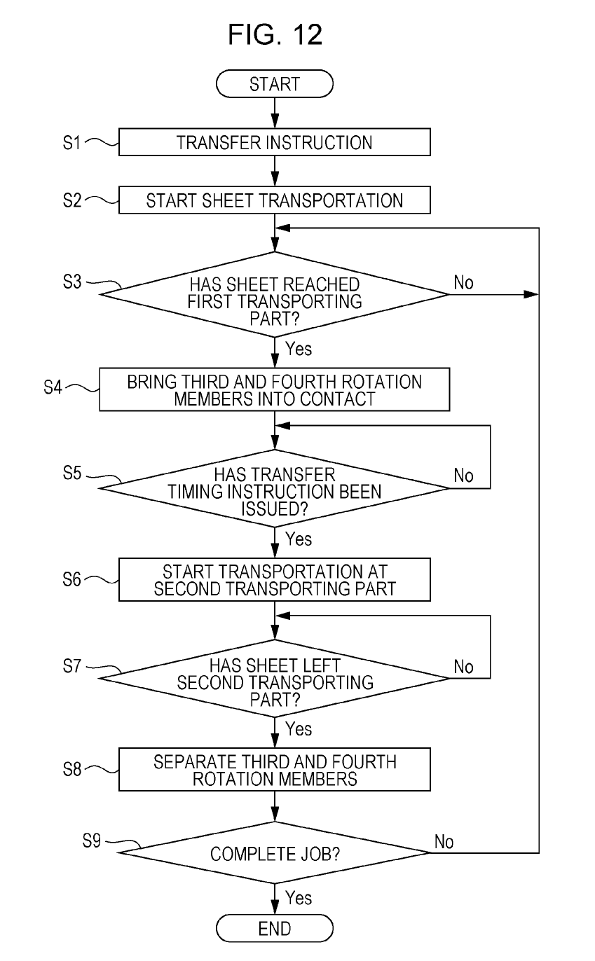

This control is described with reference to FIG. 1 and the flowchart in FIG. 12.

In the image forming apparatus 10, when the controller issues a transfer instruction (step S1), a sheet P starts to be transported from the tray unit 16 by the transporting part 44 (step S2).

The sheet P is transported toward the first transporting part 62 of the transport device 60, and a detector (not shown) determines whether or not the sheet P has reached the first transporting part 62 (step S3).

When it is determined that the sheet P has reached the first transporting part 62, the moving mechanism 120 in the second transporting part 82 is driven to bring the circular-truncated-cone-shaped rollers 88 of the third rotation member 84 into contact with the rollers 98 of the fourth rotation member 94 (step S4).

At this time, the sheet P is being transported by the first transporting part 62, and the leading end of the sheet P comes into contact with the third rotation member 84 and the fourth rotation member 94 in the second transporting part 82 and stops.

When the controller issues a transfer timing instruction (step S5), the sheet P starts to be transported while being nipped between the third rotation member 84 and the fourth rotation member 94 in the second transporting part 82 (step S6).

A detector (not shown) determines whether or not the sheet P has left the second transporting part 82 (step S7). When it is determined that the sheet P has left the second transporting part 82, the controller drives the moving mechanism 120 to move the third rotation member 84 of the second transporting part 82 away from the fourth rotation member 94 (step S8).

This series of control steps is repeated until one job is completed (step S9).

As has been described above, in this exemplary embodiment, the third rotation member 84 and the fourth rotation member 94 are brought into contact with each other while the sheet P is passing through the transport device 60.

Hence, as shown in FIG. 11C, in a state in which the rollers 98 are separated from the third rotation member 84 in the arrow h direction, the rollers 98 of the fourth rotation member 94 can easily maintain the shapes before being in contact with the third rotation member 84, and thus, deformation of the outer circumferential surfaces of the fourth rotation member 94 is minimized.

As has been described in detail above, in this exemplary embodiment, the moving mechanism 120 that brings the third rotation member 84 and the fourth rotation member 94, which is provided so as to oppose the third rotation member 84, toward and away from each other is provided.

The provision of the moving mechanism 120 minimizes deformation of the outer circumferential surfaces of the rollers 98 of the fourth rotation member 94, compared with a configuration in which the third rotation member 84 and the fourth rotation member 94 in the second transporting part 82 are kept in contact with each other.

The moving mechanism 120 separates the third rotation member 84 and the fourth rotation member 94 in the time between when the sheet P has left the second transporting part 82 and when the subsequent sheet P is transported to the first transporting part 62.

This configuration minimizes deformation of the outer circumferential surfaces of the rollers 98 of the fourth rotation member 94, compared with a configuration in which the third rotation member 84 and the fourth rotation member 94 in the second transporting part 82 are kept in contact with each other after the sheet P has left the second transporting part 82.

The moving mechanism 120 brings the third rotation member 84 and the fourth rotation member 94 into contact with each other after a subsequent sheet P, which follows the sheet P that has left the second transporting part 82, starts to be transported to the first transporting part 62 and before the subsequent sheet P leaves (has passed through) the second transporting part 82.

Hence, deformation of the outer circumferential surfaces of the rollers 98 of the fourth rotation member 94 is minimized, compared with a configuration in which the third rotation member 84 and the fourth rotation member 94 in the second transporting part 82 have been in contact with each other before the sheet P is transported to the first transporting part 62.

Although the exemplary embodiments of the present invention have been described above, these exemplary embodiments are merely examples. It is to be understood that the present invention can be variously modified without departing from the spirit thereof, and the scope of the present invention is of course not limited to these exemplary embodiments.

For example, in this exemplary embodiment, it has been described that the first rotation member 64 and the second rotation member 74 include multiple cylindrical rollers 68 and 78, respectively, that are arranged at intervals, and the rollers 68 and 78 face each other.

However, one or both of the first rotation member and the second rotation member may have a single roller, or the multiple rollers may be arranged side-by-side.

Although it has been described that the second rotation member in the first transporting part and the fourth rotation member in the second transporting part are driving elements, the second rotation member may be selectively replaced with the first rotation member in the first transporting part, and the fourth rotation member may be selectively replaced with the third rotation member in the second transporting part.

Furthermore, in the third rotation member 104, the positions of the cylindrical roller 110 and the circular-truncated-cone-shaped rollers 108 may be switched in the apparatus depth direction D. In that case, the sheet detecting device 112 provided on the upstream side of the cylindrical roller 110 in the sheet transport direction is also moved to the other side.

The first to fourth rotation members each have a shaft and rollers. The shaft and the rollers may be either formed separately and fixed together or formed as a single component.

Although it has been described that the moving mechanism 120 brings the third rotation member 84 upward to separate the third rotation member 84 from the fourth rotation member 94, it may be configured such that the moving mechanism 120 brings the fourth rotation member 94 downward to separate the fourth rotation member 94 from the third rotation member 84.

Alternatively, it may be configured such that the third rotation member 84 and the fourth rotation member 94 are moved so as to be separated from each other.

The timings of bringing the third rotation member 84 and the fourth rotation member 94 toward and away from each other may be different from those described in the flowchart in FIG. 12.

For example, although it has been described that the third rotation member 84 and the fourth rotation member 94 are separated when the sheet P has left the second transporting part 82, the third rotation member 84 and the fourth rotation member 94 may be separated when one job is completed.

Alternatively, the third rotation member 84 and the fourth rotation member 94 may be separated when predetermined multiple number of jobs are completed, or the multiple number of jobs and data about predetermined number of sheets P printed may be combined to determine the timing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transport device comprising:
a first transporting part that transports a medium; and
a second transporting part that includes a pair of transport members each having a shaft and a plurality of rotary members arranged at intervals in an axial direction, wherein,
the second transporting part transports the medium while nipping the medium between the pair of transport members after a leading end of the medium transported by the first transporting part comes into contact with the transport members, and
at least one of the plurality of rotary members of one transport member is a circular-truncated-cone-shaped rotary member in which a diameter of one base is larger than a diameter of the other base.

2. The transport device according to claim 1, wherein the one transport member has a plurality of the circular-truncated-cone-shaped rotary members arranged so as to be oriented axially outward from a central position, which is in a middle between the rotary members located at extreme outside positions in the axial direction of the shaft, the bases of the circular-truncated-cone-shaped rotary members closer to the central position having a smaller diameter.

3. The transport device according to claim 2, wherein the difference in diameter between the one base and the other base of the circular-truncated-cone-shaped rotary members located at the extreme outside positions is larger than that of the circular-truncated-cone-shaped rotary members located closer to the central position.

4. The transport device according to claim 1, wherein
the one transport member has, on one side in the axial direction, a cylindrical rotary member having an outer circumferential surface that is parallel to the axial direction, and a plurality of the circular-truncated-cone-shaped rotary members arranged at intervals so as to be oriented from a side closer to the cylindrical rotary member toward a side farther from the cylindrical rotary member, and
inclination of the outer circumferential surface of each circular-truncated-cone-shaped rotary member is formed by making the base farther from the cylindrical rotary member have a larger diameter than the base closer to the cylindrical rotary member in the axial direction.

5. The transport device according to claim 4, further comprising a medium-position detector that detects a position of the medium in a direction perpendicular to a medium transport direction, the medium-position detector being provided on a downstream side of the first transporting part and on an upstream side of the cylindrical rotary member in the transport direction.

6. The transport device according to claim 4, wherein the inclination gradually increases from the side closer to the cylindrical rotary member toward the side farther from the cylindrical rotary member.

7. The transport device according to claim 5, wherein the inclination gradually increases from the side closer to the cylindrical rotary member toward the side farther from the cylindrical rotary member.

8. The transport device according to claim 1, further comprising a moving mechanism that brings the one transport member and the other transport member, which is provided so as to oppose the one transport member, toward and away from each other.

9. The transport device according to claim 2, further comprising a moving mechanism that brings the one transport member and the other transport member, which is provided so as to oppose the one transport member, toward and away from each other.

10. The transport device according to claim 3, further comprising a moving mechanism that brings the one transport member and the other transport member, which is provided so as to oppose the one transport member, toward and away from each other.

11. The transport device according to claim 4, further comprising a moving mechanism that brings the one transport member and the other transport member, which is provided so as to oppose the one transport member, toward and away from each other.

12. The transport device according to claim 5, further comprising a moving mechanism that brings the one transport member and the other transport member, which is provided so as to oppose the one transport member, toward and away from each other.

13. The transport device according to claim 6, further comprising a moving mechanism that brings the one transport member and the other transport member, which is provided so as to oppose the one transport member, toward and away from each other.

14. The transport device according to claim 7, further comprising a moving mechanism that brings the one transport member and the other transport member, which is provided so as to oppose the one transport member, toward and away from each other.

15. The transport device according to claim 8, wherein the moving mechanism moves the one transport member and the other transport member away from each other after the medium leaves the second transporting part and before a subsequent medium is transported to the first transporting part.

16. The transport device according to claim 8, wherein the moving mechanism brings the one transport member and the other transport member into contact with each other after a subsequent medium, which follows the medium that has left the second transporting part, starts to be transported to the first transporting part and before the subsequent medium leaves the second transporting part.

17. The transport device according to claim 15, wherein the moving mechanism brings the one transport member and the other transport member into contact with each other after a subsequent medium, which follows the medium that has left the second transporting part, starts to be transported to the first transporting part and before the subsequent medium leaves the second transporting part.

18. An image forming apparatus comprising:
a transfer unit that transfers a toner image to a medium; and
the transport device according to claim 1 disposed on an upstream side of the transfer unit in a medium transport direction.

19. A transport device comprising:
first transporting means for transporting a medium; and
second transporting means that includes a pair of transport members each having a shaft and a plurality of rotary members arranged at intervals in an axial direction, wherein,
the second transporting means transports the medium while nipping the medium between the pair of transport members after a leading end of the medium transported by the first transporting means comes into contact with the transport members, and
at least one of the plurality of rotary members of one transport member is a circular-truncated-cone-shaped rotary member in which a diameter of one base is larger than a diameter of the other base.
